(19) United States
(12) Patent Application Publication
(10) Pub. No.: US 2025/0080262 A1
(43) Pub. Date: Mar. 6, 2025

(54) SYSTEM, APPARATUS, AND METHOD TO MANAGE MULTIPLE PRECISION TIME PROTOCOL DOMAINS

(71) Applicant: Arista Networks, Inc., Santa Clara, CA (US)

(72) Inventors: Scott William Hill Bailey, New Westminster (CA); Gerard Neale Phillips, Winchester (GB); Avininderpal Singh Grewal, Langley (CA); Jeff Jing Yuen Chan, Burnaby (CA)

(21) Appl. No.: 18/619,087

(22) Filed: Mar. 27, 2024

Related U.S. Application Data
(60) Provisional application No. 63/536,614, filed on Sep. 5, 2023.

(51) Int. Cl. H04J 3/06

(52) U.S. Cl. CPC H04J 3/0658

(57) ABSTRACT

Particular embodiments described herein provide for a system, an apparatus, and a method to manage precision time protocol (PTP) domains with different domain numbers. The system, apparatus, and method can include activities for receiving an incoming PTP message at a logical PTP interface, which corresponds to one or more PTP ports of the network element; the incoming PTP message includes a first domain number. The activities also include translating the first domain number of the incoming PTP message into a second domain number to be included in a field of an outgoing PTP message, the translating includes identifying an active domain number entry in an active domain numbers database that includes the second domain number and that is part of a configuration, which allows domain number translations for a PTP region that is defined by its PTP domain and that corresponds to the logical PTP interface.

### CLAIMING PRIORITY TO A PROVISIONAL

This application claims Priority under any and all relevant provisions of 35 U.S.C. to the Provisional Application having Ser. No. 63/536,614, which was filed on Sep. 5, 2023 and which is hereby incorporated by reference in its entirety.

### TECHNICAL FIELD

This disclosure relates in general to the field of computing and/or networking and, more particularly, to a system, an apparatus, and a method to manage multiple precision time protocol domains.

### BACKGROUND

The Precision Time Protocol (PTP) allows for the distribution of sub-microsecond accurate time across an L2/L3 network. The PTP is defined by IEEE 1588 V2 and IEEE 802.1AS. A PTP domain can refer to a network that is enabled with PTP. A PTP domain has only one reference clock, sometimes referred to as a master clock or grandmaster clock. Devices in the domain synchronize to the reference clock. PTP messages contain a domain number and each PTP domain is typically configured to work with one, and only one, domain number. Each PTP domain is configured to ignore messages with any other domain number. This allows different independent timing systems to inhabit the same network without confusing each other.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a general system to help manage multiple precision time protocol domains, in accordance with an embodiment of the present disclosure;

FIG. 1B is a simplified block diagram of a particular implementation of a system that includes multiple regions for managing multiple precision time protocol domains, in accordance with an embodiment of the present disclosure;

FIG. 2 is a simplified block diagram of a particular implementation of a system to help manage multiple precision time protocol domains in which one of the domains includes a rogue region domain number, in accordance with an embodiment of the present disclosure;

FIG. 3 is a simplified block diagram of a portion of a network element that includes a precision time protocol engine to help manage multiple precision time protocol domains, in accordance with an embodiment of the present disclosure;

FIG. 4 is a simplified block diagram of a precision time protocol message receiver engine to help manage multiple precision time protocol domains, in accordance with an embodiment of the present disclosure;

FIG. 5 is a simplified block diagram of a portion of a precision time protocol message transmission engine for managing multiple precision time protocol domains, in accordance with an embodiment of the present disclosure;

FIG. 6 is a simplified block diagram illustrating example details of a portion of a precision time protocol packet, in accordance with an embodiment of the present disclosure;

FIGS. 7A-7F are simplified uses cases illustrating example scenarios for managing multiple precision time protocol domains, in accordance with an embodiment of the present disclosure;

FIG. 8 is a simplified block diagram illustrating example details of a portion of a domain database set, in accordance with an embodiment of the present disclosure;

FIG. 9 is a simplified block diagram illustrating example fields and attributes of a portion of a domain database to be used in managing precision time protocol domains, in accordance with an embodiment of the present disclosure;

FIG. 10 is a simplified flowchart illustrating potential operations that may be associated with a system to help enable sending a precision time protocol message to multiple precision time protocol domains in accordance with an embodiment of the present disclosure;

FIG. 11 is a simplified flowchart illustrating potential operations that may be associated with a system for enabling a mapping to a domain database in accordance with an embodiment of the present disclosure; and

FIG. 12 is a simplified flowchart illustrating potential operations that may be associated with a system for removing a domain number from a list of active domain numbers in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to managing multiple PTP domains in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

In an example, a precision time protocol (PTP) time domain can include multiple PTP domains that use different internal “in-the-packet” domain numbers. A system and a method can merge regions of the PTP time domain that use different in-the-packet domain numbers into a single logical PTP time domain to help manage the multiple PTP domains. More specifically, the multiple PTP domains can be merged or coalesced into a single logical PTP time domain with a common reference clock. The architecture can support logically merging regions of a logical PTP time domain that differ in their configured domain number identifier for the domain, but that are intended to synchronize using PTP. In an example, the architecture can translate and manage arbitrary domain numbers on a PTP boundary clock node to help manage multiple PTP domains.

PTP defines the following three types of basic clock nodes: an ordinary clock node, a boundary clock node, and a transparent clock node. The ordinary clock node can include a PTP clock with a single PTP port in a PTP domain for time synchronization. The ordinary clock node synchronizes time from its upstream clock node through the PTP port. If a clock node operates as the clock source and sends synchronization time through a single PTP port to its downstream clock node, it is also referred to as an ordinary clock node.

The boundary clock node can include a clock with more than one PTP port in a PTP domain for time synchronization. A boundary clock node uses one of the PTP ports to synchronize time from its upstream clock node, and uses the other PTP ports to synchronize time to the relevant downstream clock nodes. If a clock node operates as the clock source and synchronizes time through multiple PTP ports to its downstream clock nodes, it is also referred to as a boundary clock node.

The transparent clock node does not need to keep time consistency with other clock nodes. A transparent clock node has multiple PTP ports. The transparent clock node only forwards PTP messages among these ports and performs delay corrections for the messages, instead of performing time synchronization. Network operators should efficiently manage and optimize all such PTP activities, while minimizing the processing overhead of associated network elements.

PTP deployments have the ability to grow/change frequently based on mergers and acquisitions, especially for mobile media and entertainment deployments (e.g., media trucks). Currently, networks that change physically or logically and that seek to share a single time domain would have the devices adjusted to operate using the same domain number. The domain number is an identifier carried in every PTP message (e.g., in the range 0-255). Typically, if the domain number is not manually adjusted, connecting a network or device that is currently configured with a different domain number would result in messages being ignored and PTP synchronization not occurring.

The architecture disclosed herein can, inter alia, provide the capability for PTP network operators to reduce configuration changes, especially changes on devices/networks that are not easily accessible or configurable. More specifically, regions that differ in their configured domain number identifier for the PTP time domain can be merged using static domain number translations, multiple number static translations, domain number learn and lock-on translations, and multiple domain number learn-all translations, as described in more detail below.

Logically merging regions that differ in their configured domain number into a single logical PTP time domain allows the architecture to manage inflexible devices, as well as providing automatic reconciliation of domain number differences between regions of the time domain. Merging boundary clocks with different domain numbers is achieved by considering the different domain numbers as a single mergeable logical domain, where the boundary clock(s) of regions that have different domain number configurations are grouped into a single logical PTP time domain.

The media and entertainment deployments of PTP are known to be especially applicable for the architecture described herein. The various end-PTP devices deployed and the requirements to manage constantly changing topologies and network interconnections mean that the media and entertainment deployments are especially burdened by having to reconfigure the domain number identifier used by each device. The architecture described herein helps to avoid having to reconfigure the domain number identifier used by each device by merging multiple PTP domains with different domain numbers into a single logical time domain. The term ‘merging’ as used herein is a broad term that encompasses any activities associated with managing, uniting, coalescing, joining, or otherwise processing PTP data of any kind across different PTP domains.

### Example Systems, Apparatuses, and Methods

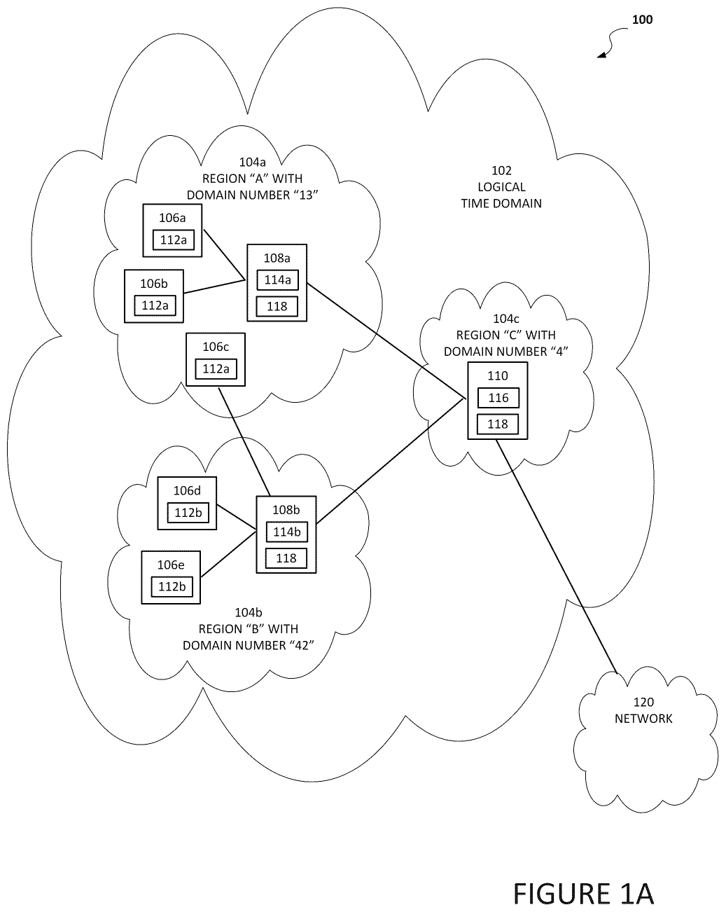

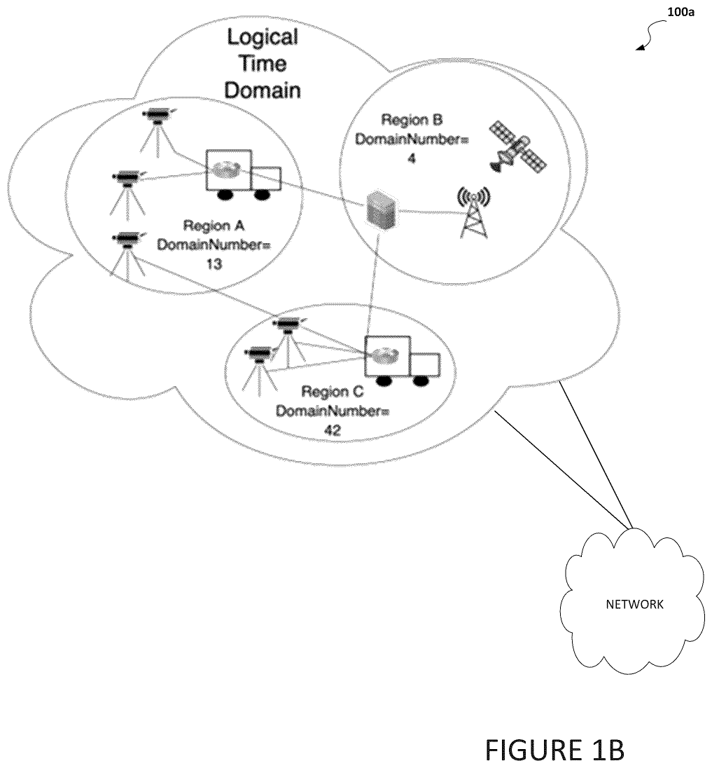

FIG. 1A is a simplified block diagram of a system 100 to manage multiple PTP domains. Referring to FIG. 1A, the system 100 can include a logical time domain 102, which can include a plurality of PTP regions 104a-c. One or more of the PTP regions 104a-c can have a different domain number. For example, as illustrated in FIG. 1A, PTP region 104a can have a domain number of “13,” PTP region 104b can have a domain number of “42,” and PTP region 104c can have a domain number of “4.”

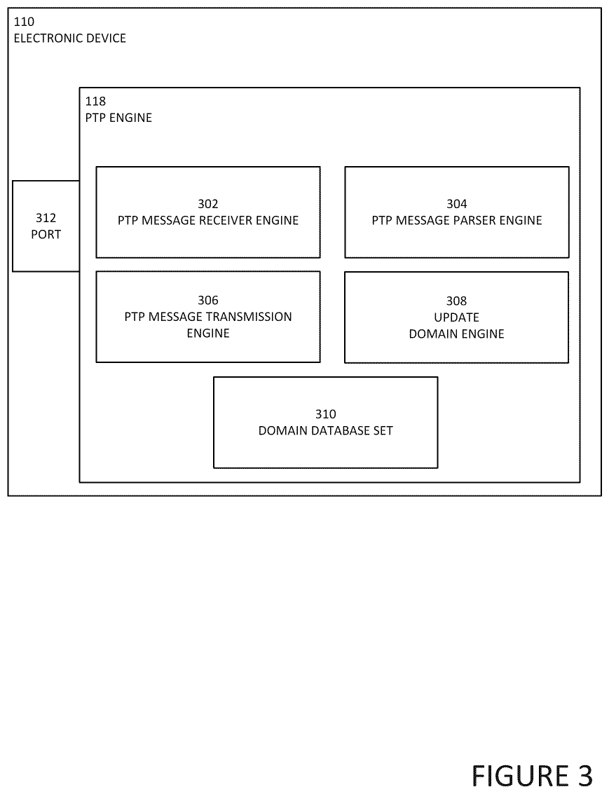

PTP region 104a can include one or more respective ordinary clock nodes 106a and/or one or more boundary clock nodes 108a. Each of the one or more ordinary clock nodes 106a-e can include an ordinary clock 112a-b and each of the one or more boundary clock nodes 108a-b can include a respective boundary clock 114a-b. In some examples, one or more of the boundary clock nodes may include a PTP engine 118. For example, as illustrated in FIG. 1A, the PTP region 104a includes ordinary clock node 106a, ordinary clock node 106b, ordinary clock node 106c, and boundary clock node 108a. The PTP region 104c can include a network element 110 that represents any suitable switch, gateway, router, proprietary network element or the like that can enable the management of multiple PTP domains as discussed herein. In some examples, the network element 110 also includes the PTP engine 118, which is further detailed below with respect to FIG. 3. The network element 110 can readily communicate with network 120 (e.g., the Internet) using suitable interfaces and protocols.

Turning to FIG. 1B, FIG. 1B is a simplified block diagram of a particular non-limiting implementation of a system 100a that illustrates specific regions and domain numbers for purposes of teaching and explanation. In this example, the network element 110 can include a reference clock, which can be considered as a master clock with a domain number “4” for the corresponding PTP region. In operation, PTP messages can be used to synchronize or set the ordinary clocks and the boundary clocks to the reference clock. For example, the network element 110 can generate a PTP message with the reference domain number “4” to synchronize the clocks in the logical time domain 102. The boundary clock node can receive the PTP message with the reference domain number “4” and translate the PTP message into a translated PTP message with the domain number “13” so the PTP message will be received by ordinary clock nodes. More specifically, a PTP instance within a given network element (e.g., a switch) can perform this translation activity. A PTP instance, at its most basic level, is simply a piece of software code compatible with the precision time protocol. Additionally, it can be any implementation of the IEEE 1588 Specification's data sets, algorithms, and processes. In particular embodiments discussed herein, it reflects an instance of a PTP boundary clock.

Note that networks that change physically or logically and that seek to share a single time domain would have devices adjusted to operate using a single, same domain number. The domain number is simply an identifier carried in every PTP message, but if the domain number is not adjusted, connecting anything having a different domain number would result in messages being ignored or synchronization not being possible. When networks or devices are moved or joined, the devices will be reconciled to a common configuration manually. No devices with mutually exclusive sets of supported domain numbers can be used together. For example, if a simple device “A” only supports using the default domain “0”, but another device requires that a user-defined domain number “4-127” is used, these two devices are not compatible.

A PTP deployment could work around this problem by using devices that implement full membership of boundary clocks into multiple time domains. For example, parallel simultaneous membership can be implemented for each domain number into each affected clock, and the network can be modeled as containing multiple separate logical PTP time domains. However, clocks would participate fully in each domain, select the best reference clock for each domain, propagate the time of each domain throughout the network, and maintain state models (operating the processes for each domain). Connected devices would receive time for each domain and likely only synchronize using messages matching the locally configured domain number. However, implementing full membership of boundary clocks into multiple time domains requires high processing usage, generates unwanted network congestion, and taxes memory resources to maintain multiple full instances of PTP. What is needed is an architecture to coalesce multiple PTP domains without having to repeatedly reconfigure these domains manually.

The architectures of both FIGS. 1A and 1B can offer a system, a method, and an apparatus to enable an intelligent grouping/merging of multiple PTP domains can help resolve these issues (and others). In operation, the architectures can merge regions of a PTP time domain, where one or more regions use different in-the-packet domain numbers, into a single logical PTP time domain. More specifically, the architectures can translate and manage arbitrary domain numbers on a PTP boundary clock to support logically merging regions that differ in their configured domain numbers. Synchronizing multiple different domain numbers into a single logical PTP time domain allows multiple PTP domains with one or more different domain numbers to coalesce into a single logical PTP time domain.

The architecture disclosed herein can, inter alia, provide the capability for PTP network operators to reduce configuration changes, especially changes on devices/networks that are not easily accessible or configurable. More specifically, regions that differ in their configured domain number identifier for the PTP time domain can be merged using static domain number translations, multiple number static translations, domain number learn and lock-on translations, and multiple domain number learn-all translations. For static translation and multiple domain number static translations, the allowed domain numbers configuration is inferred to be exactly the same as the static values provided for translation explicitly. For learn based implementations, if no allowed domain numbers configuration is present, the domain numbers are allowed, if any policy regarding allowed domain numbers is present, it is a default-deny system, where only explicitly allowed ranges and numbers of domains will be accepted per the policy regarding allowed domain numbers.

Each translation/handling implementation can support multiple PTP logical interface scopes, including per PTP physical port translation, virtual local area network (VLAN) aware-per physical port translation, and multi-chassis link aggregation (MLAG) aware per MLAG interface translation. The logical interface scopes can readily support overlapping configurations. For example, a physical port might statically translate the PTP domain number of a connected region using one domain number, while at the same time translating VLAN tagged PTP messages using different domain numbers per PTP VLAN. Using different logical interface scopes, the architecture can manage one or more regions connected to the same or multiple physical interfaces of the switch or even share common domain number handling between multiple physical switches in the case of an MLAG interface. The different types of translations and different types of PTP logical interface scopes can be mix-and-matched to provide a great deal of flexibility to an operator looking to configure a switch as a boundary clock node in a time domain with one or more domain number regions for different Use Cases. The architecture discussed herein can also be configured to deny or allow domain numbers at interface scopes to provide the operator with control over acceptable domain number regions (i.e., acceptable domain numbers) that may be merged at a configured logical interface of the boundary clock node. The architecture discussed herein can also secure against processing/learning of rogue domain numbers using a deny/allow system.

The architecture can include a domain database set that is a wrapper for individual domain databases. More specifically, the domain database set represents a plurality of domain number databases, where each logical PTP interface is associated with a domain number database from the plurality of domain number databases. In some examples, the domain database set is a singleton lookup table that can include one domain database per PTP enabled logical interface on the system. Other examples involve multiple domain databases per PTP enabled logical interfaces on the system. In still other examples, the domain database set can also be modeled as a database within which entries are of a single type and function as a per logical interface domain database.

The plurality of domain number databases can include data model encapsulation (e.g., providing required state for the operation of the flexible domain numbering system), and can help provide access to information required by the PTP message processing for transmission and reception. The plurality of domain number databases can also allow for access to the information required by the PTP message processing for transmission and reception and allow for minimal processing per message, which is especially important for PTP where there can be tens or hundreds of messages created and received per interface per second. Non-critical logic can be performed on a deferred basis for the system to return back to critical message processing. The plurality of domain number databases can also include extensions for translation methodology-specific state as required by the instantiated PTP domain number handling implementation for the logical interface (e.g., domain number learning metadata).

In one non-limiting example, a domain database manager can be configured to maintain the active domain database of active domain numbers set per logical interface. This can include configuration handling and dynamic learning of domain numbers, along with the removal of stale or aged domain numbers. In some examples, the domain database manager can be configured to update an active domain numbers set (a set or listing of currently active domains) for a given logical interface at the time of receiving or sending a PTP message, or based on any other suitable event triggers (e.g., update domains). The learning of new domains can be generalized regardless of the domain handling implementation. For static implementations, the effective allowed domain numbers include the static domain numbers and, thus, learning is a no-op (or skippable operation). For lock-on implementations, the allowed domain numbers are either from the user configuration, or solely the locked-on domain number if present. The removal of stale domains can be generalized regardless of the domain handling implementation selected. For static or lock-on implementations, the effective domain number age limit is infinite for active domain numbers. Maintaining the active domain database per logical interface can also include set or range of domain number resolution, as well as peer synchronization with other PTP systems in the case where logical interfaces can include network interfaces on different devices, for example, in the case of MLAGs. The logical interface can be many-to-one logical interfaces per network interface (e.g., per VLAN), one-to-many logical interface to network interfaces (e.g., link aggregation (LAG)), one-to-many logical interfaces, including one or more interfaces on different systems (e.g., MLAG), or any other logical interface configuration.

The domain database manager can also be configured to query for acceptable in-the-packet domain numbers for receiving messages per interface (domain acceptability). For example, the domain database manager can be configured to use a PTP's message type, a PTP's local logical interface, and/or a PTP messages per PTP port in a query to help determine that if the packet will be processed in-the-packet domain number and use the in-the-packet domain number for new egress messages (destination domain resolution). The PTP port can be a physical port or a virtual port.

A PTP engine (detailed below with reference to FIG. 3) can also be configured to provide state information for user visible debugging. More specifically, to assist with user debugging, the system can allow text-based command line monitoring of active domain numbers per interface, SDK/Web based encoded state, system logging of domain number changes for operator monitoring purposes, packet drop counters for unacceptable domain numbers, etc. (Drop Packet). Each of the above does not need to happen serially during PTP message handling and can be deferrable.

The system can decouple the domain number identifier from the logical PTP time domain and allow for granular control per logical interface for domain number region managing, rather than supporting a particular configuration per clock. Decoupling the domain number identifier from the logical PTP time domain allows for the ability to define allowable regions to merge automatically, rather than with manual configuration intervention per device in the topology. In addition, decoupling the domain number identifier from the logical PTP time domain helps to avoid the processing and scaling issues associated with current systems that manually reconcile full overlapping time domains (parallel instances of PTP on each clock).

Each implementation of the architecture described herein, as well as its application in conjunction with the concepts of logical PTP interfaces, which includes physical PTP ports, VLAN aware PTP ports, and MLAG PTP interfaces. This PTP interface can help provide operators with fine-tuned control of the activities discussed herein. One basic example of a logical PTP interface would be a physical port, or optionally multiple logical ports per physical port (e.g., using particular VLANs for the physical port). Additionally, the architecture discussed herein can hand off options for managing domain numbers in regions of a given PTP time domain network. In other words, rather than having to define a global table on the device that translates domain X to domain Y, which would be limited to non-conflicting mappings for the connected regions, the system allows for many logical organizations of the logical PTP region based on physical or network-based connections.

The purpose of a PTP profile (e.g., identified in IEEE 1588 19.3 PTP Profiles and IEEE 1588 19.3.1.1 General) would be to allow specific selections of attribute values and optional features of the PTP that, when using the same transport protocol, achieve a performance that meets the requirements of a particular application. A PTP profile can be a set of required options, prohibited options, and the ranges and defaults of configurable attributes that are consistent with the IEEE 1588 specifications in sections 19.2.1 and 19.2.2. In juxtaposition, the architecture described herein is not a static profile of options, attributes, and defaults. As mentioned above, the per-logical-interface view of the configuration of this set of features is an enhancement of the PTP in that typical profiles have common values applied to the clock's ports that are operating in the same mode. The learning style of the architecture provides dynamic handling of topology changes that avoid manual human interventions.

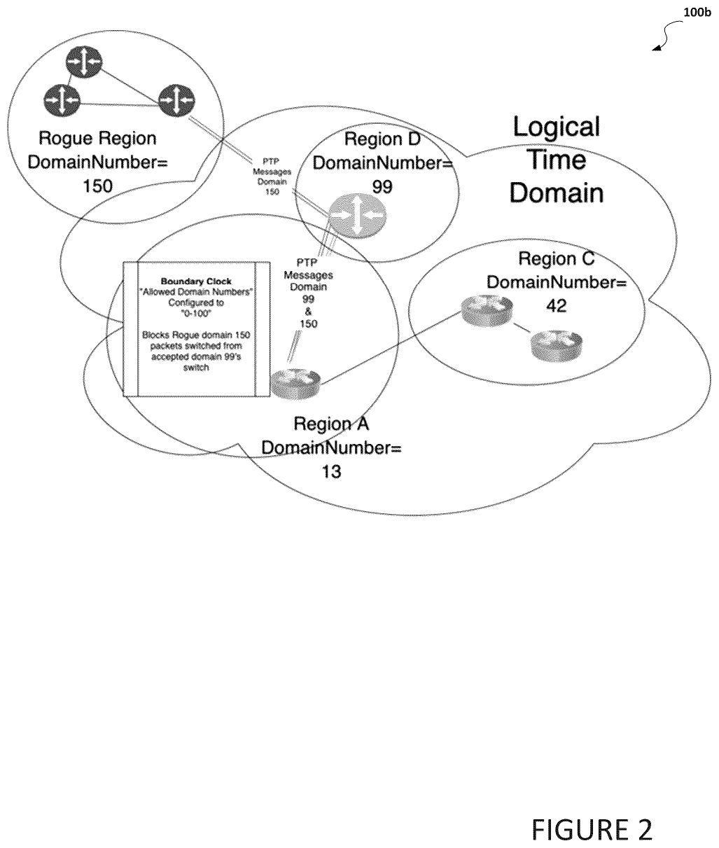

Turning to FIG. 2, FIG. 2 is a simplified block diagram of a particular non-limiting implementation of a system 100b to manage multiple PTP domains. The multiple PTP domains can be merged or otherwise coalesced into a single logical PTP time domain with a common reference clock. As illustrated in FIG. 2, the system 100b can include a rogue region with a domain number “150.” The rogue region with the domain number “150” is not part of the logical time domain. Region D is associated with domain numbers 99, region C is associated with domain numbers 42, and region A is associated with domain numbers 13, where a boundary clock is provisioned between regions A and D. As illustrated in FIG. 2, the PTP messages from the rogue region with the domain number “150” are blocked or ignored.

To provide limits/control, the implementations discussed herein can, inter alia, also apply limits to allowed translations to optionally counterbalance the dynamic nature of the translations and avoid rogue/unintended events from affecting the system. The allowed translations are based on allowed domain numbers. Allowed domain numbers are domain numbers that can be in the lookup tables and that are used when updating or adding domains to the lookup tables (e.g., if a domain number is an allowed domain number, then it can be added to the lookup table, if the domain number is not an allowed domain number, then it is not added to the lookup table), as compared to acceptable domain numbers that are the result of a query using the lookup tables for a given PTP packet received on a specific port and that are based on the live state of the mappings at the time of receiving a message. These limits can include optional range-set configurations provided per configured logical interface. For example: “domain number limits: 10-30, 42,45,47” would allow the logical interface to learn and lock onto a domain number so long as that number was within the range 10-30, or exactly 42, 45 or 47. Operators of the system will have a known few domain numbers they might need to handle but any others should be ignored as external to the potential set of domain numbers used in the logical time domain.

The architecture disclosed herein can allow for ease of debugging, time domain event history, and proactive notification state to be produced (system logs, message counters, state of each logical interface's domain database in a human readable format). More specifically, any PTP network operator could make use of these features to perform debugging, segmentation or other application specific functions based on renumbering domain numbers between regions in a PTP time domain.

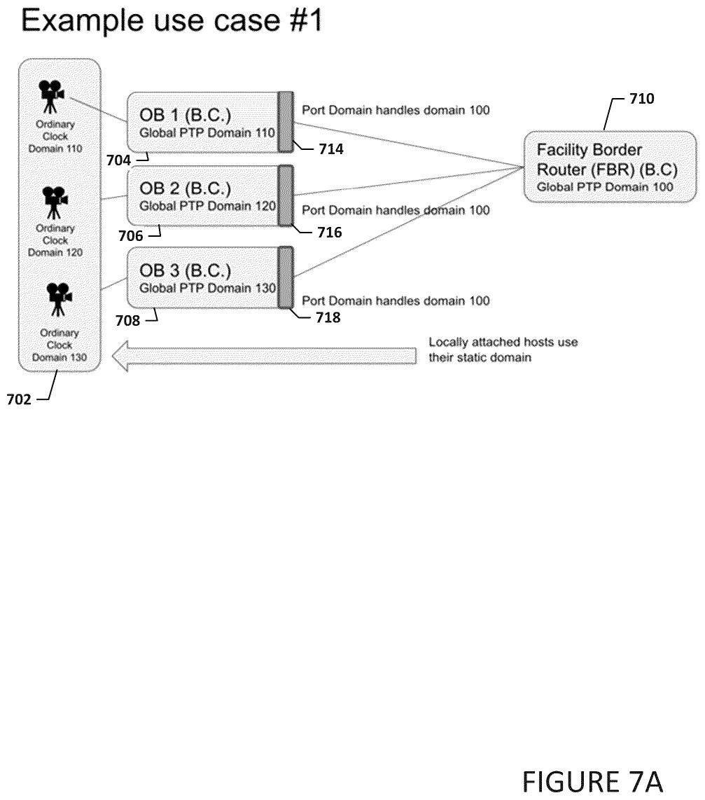

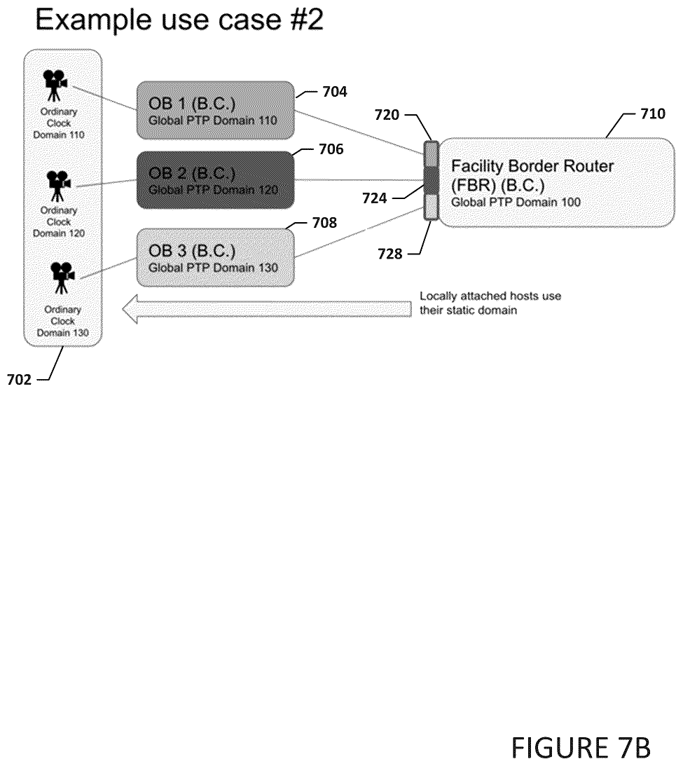

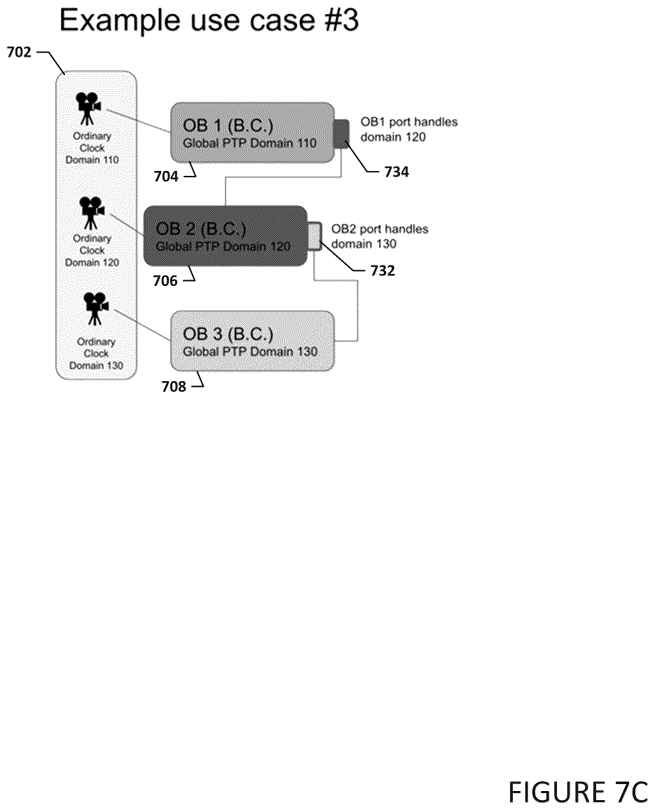

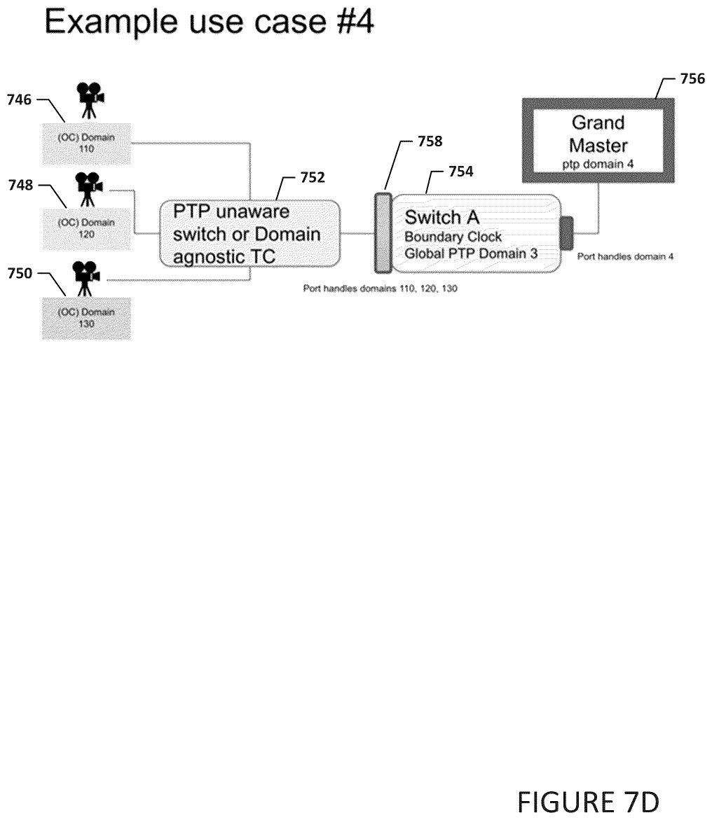

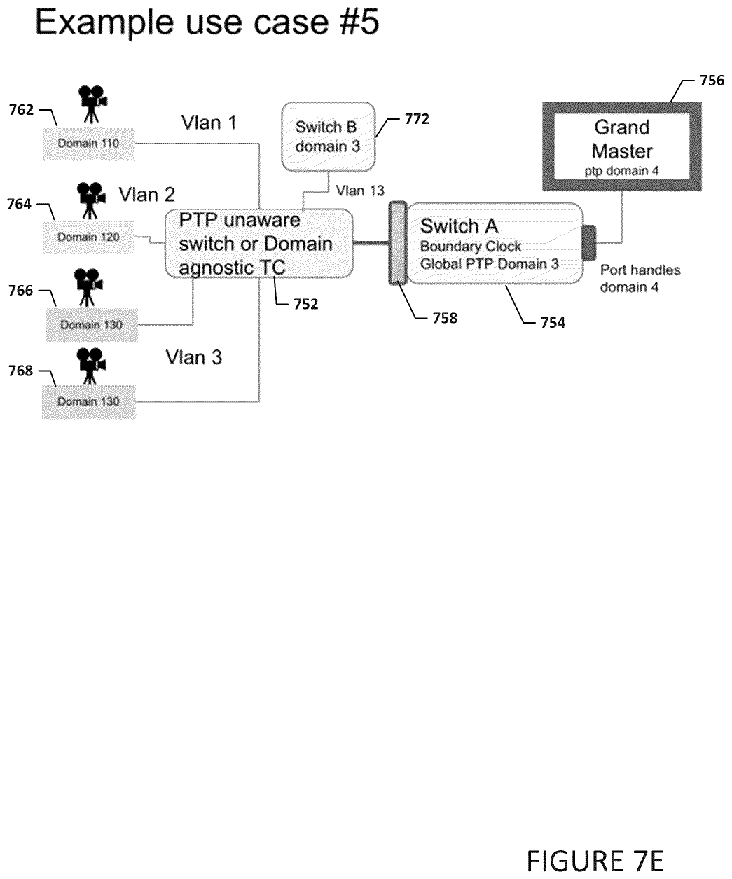

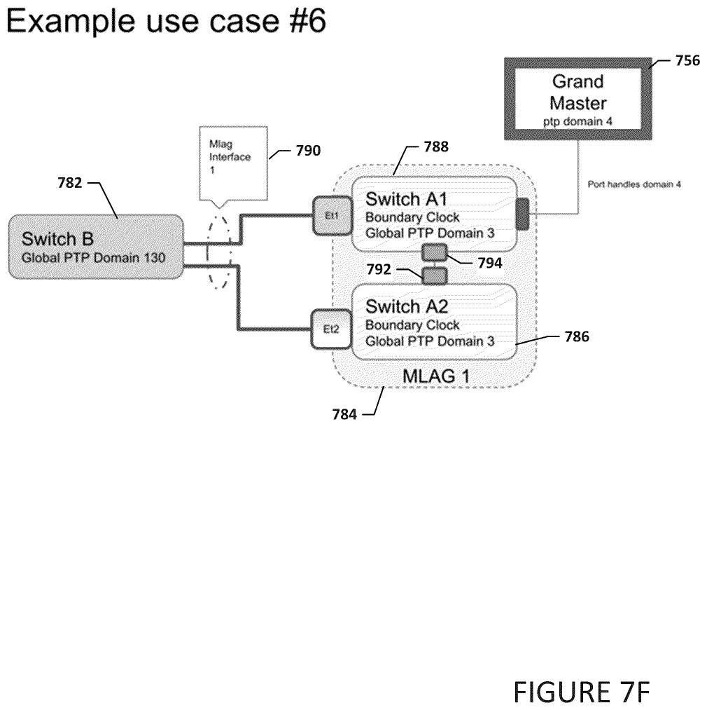

In an illustrative example, the simplest set of implementations are those that translate statically per logical PTP interface. The PTP interface replaces incoming PTP message's domain number based on the active domain numbers database that includes only a single entry and can be configured statically. Static translation per logical PTP interface covers the requirements of Use Cases #1-#3 and #6 (illustrated in FIGS. 7A-7C and 7F). Static translation per logical PTP interface does not support handling multiple locally connected domain number regions for a single logical interface and does not support automatically managing region-merging. Also, static translation per logical PTP interface does help to prevent accidental rogue domain numbers from merging.

Similar to the static translation implementation, a multiple static domain number translation allows an operator to choose a static configuration to represent the allowed translations for the PTP regions connected to the logical PTP interface. However, the capabilities and behavior of the multiple static domain number translation are quite different when compared to the single static translation implementation. For example, when multiple domain numbers are supported statically on the interface, the PTP interface no longer has a notion of what domain number to use by default. To support handling and generating PTP messages for multiple domain numbers on a single interface, a database of the active domains per interface, which are simply the statically configured set, can be maintained. Received messages are accepted if they are a member of this set. Transmitted messages may be replicated per connected region's domain number from the active domain numbers set if required.

The multiple static domain number translation implementation (i.e., Use Case) covers the requirements of Use Cases #1-#6 (illustrated in FIGS. 7A-7F). The multiple static domain number translation implementation supports handling multiple domain number regions connected to the logical interface; however, the multiple static domain number translation implementation requires some manual configuration to statically configure the expected/allowable domain numbers.

Similar to the static translation implementation, a domain number learn and lock-on implementation results in an active domain numbers database with a single entry per logical PTP interface. The active domain number resolved for the interface is accepted and translated to the clock reference domain number for incoming PTP messages. The domain number learn and lock-on implementation can be used to overwrite the domain number field for outgoing PTP messages. Learning the active domain number is based on the reception of PTP messages on the logical interface. The learned and locked-on domain number may persist as long as messages are seen for this domain number more frequently than a configured timeout interval. In some examples, the configured timeout interval may be forever or a specific amount of time (e.g., one hour, six hours, seven days, etc.).

For the duration of being in the locked-on state, no other PTP domain numbers are active on the interface. For the duration of not being in the locked-on state, the domain number handling is the default for the reference clock configuration. The domain number handling is the port for the interface that sends and receives PTP messages remains inactive and does not send PTP messages until a domain number is learned and locked onto by the interface, or the port for the interface that sends and receives PTP messages, advertising itself to a set of configured allowed domains until the interface receives a PTP message from a peer and locks to the domain number of the received PTP message.

In some examples, the interface has a configuration that advertises the interface only on the reference clock domain or the interface has a list of domain numbers that an operator is expecting and will advertise on those to help to define the domain number the interface uses depending on the domain number of the upstream and downstream peer interfaces. The domain number learn and lock-on implementation covers the requirements of Use Cases #1, #2, #3 and #6 (illustrated in FIGS. 7A-7C and 7F). This domain number learn and lock-on implementation does not support multiple domain number regions connected to the logical interface at once (for example via a bridge or transparent clock).

Similar to the learn and lock-on implementation, a multiple domain number learn and translate implementation is based on learning domain numbers from incoming PTP messages per logical PTP interface. The same keep-alive and allowed domain number acceptability would apply to the multiple domain number learn and translate implementation with the exception of no explicit limit to the size of the domain number database. Note that implicitly domain numbers 0-255 are the IEEE-1588-2008 domain number range, and thus the limit is 256, Also, system restrictions (e.g., memory, processing, etc.) may further reduce the maximum number of domains that can theoretically be learned simultaneously.

Similar to the static multiple domain number implementation, the multiple domain number learn and translate implementation maintains a database of multiple active domain numbers as an active domain numbers set and received messages are accepted automatically based on being a member of the domain number database (optionally including the local globally configured domain). In this sense, the ‘local’ configuration is reflecting what is local to a switch (or similar network element). More broadly, this can be considered as a ‘default’ domain in this learn and translate scenario. If the destination PTP port ID does not have a known domain number, transmitted messages are also replicated as described in the static multiple domain number implementation discussed above. The multiple domain number learn and translate implementation covers Use Cases #1-#6 (illustrated in FIGS. 7A-7F). The multiple domain number learn and translate implementation supports automating merging domain number regions and a multiplicity of connected domain number regions per logical interface.

The PTP IEEE-1588-2008 specification defines PTP in terms of ports. Each port is implicitly a physical port. An example of a physical port is an Ethernet interface on a switch. The interface has a one-to-one relationship with the connected device's physical port and messages have only one transmit and one receive path. The PTP synchronization protocol operates on physical ports under the assumption that messages generated by the logical PTP interface are placed onto the network and there is no further multiplexing/demultiplexing detectable.

Therefore, messages sent on the physical PTP port are based on the single PTP port's protocol implementation. For the purposes of the translation features discussed herein, the implication is that messages transmitted and received on a PTP port instance represented by a physical port would utilize a single domain number database/determination. Implementations described can therefore be configured and instantiated per physical port, as opposed to requiring the same configuration to be shared among the ports.

In terms of the translating activities being performed, a PTP instance can translate one or more PTP messages between PTP regions corresponding to groupings of PTP participants in the network. The terms ‘grouping’ and/or ‘region’ allude to sets of network elements (e.g., switches, clocks, phones, cameras, software applications, etc.) that can receive and understand PTP messages. In a broad sense, the grouping is simply a logical set of devices that are using a common PTP domain number. The ‘PTP participants’ are inclusive of the aforementioned network elements (inclusive of switches, clocks, phones, cameras, software applications, etc.) that can receive and understand PTP messages.

As discussed in U.S. patent Ser. No. 11/502,767, filed Apr. 20, 2020, issued to Fong, et al., incorporated by reference in its entirety, and U.S. patent Ser. No. 11/184,097, filed Jan. 24, 2020, issued to Fong, et al., also incorporated by reference in its entirety, VLAN aware PTP can be configured to allow logically separated devices in an Ethernet network to synchronize. The PTP Port and its protocols are instantiated per Ethernet interface, per PTP VLAN. Thus, a trunk port (physical port carrying traffic for multiple VLANs) receives and transmits PTP messages for one or more PTP ports. Implementations described herein can be configured and instantiated per logical PTP interface, providing an operator with better control over acceptable domain number translation behaviors within the scope of a single physical port.

In an illustrative example of supporting three logical PTP interfaces to support each of three regions as defined by their domain number, a single physical port can be connected to ten hosts, the first two on a separate VLAN 1,2 and the remaining eight using VLAN 3 and can be managed independently. A Port X can simultaneously support static translation for host1 to translate a known expected domain number, learn and lock-on for host2 to translate any one acceptable arbitrary domain number, and multiple domain numbers learn and translate for the remaining eight devices, which could each be using a different domain number.

A MLAG is a form of IEEE 802.1AX link aggregation group wherein the constituent physical members of the link aggregation group may be on more than one physically independent switch (chassis). Logically the MLAG interface is a single network interface. As with other non-physical ports representing a PTP port, the standard does not specify the protocol, and the system can be configured to allow connected PTP devices to view the MLAG interface's members as independent ports. This helps to ensure that a connected device does not need to know that there are two connected devices, only one MLAG peer will be active for the purposes of PTP within the scope of the MLAG interface. As discussed in U.S. patent Ser. No. 11/502,766, filed Apr. 20, 2020, issued to Budnik, et al., incorporated by reference in its entirety, to help allow connected PTP devices to view the MLAG interface's members as independent ports, there is a protocol between the MLAG peers to forward PTP messages received on any member of the MLAG interface to the other peer. The system can also be configured to allow for PTP synchronizing the two MLAG switches' time. The PTP logical interface can be seen as the MLAG interface, and the implementations discussed herein can be configured and instantiated on the MLAG interface.

To help achieve the PTP logical interface being seen as the MLAG interface, the domain number database can be synchronized automatically for physical member ports on both MLAG peer chassis. As a logical single switch, each MLAG peer would also accept messages using the domain number of the peer chassis. By synchronizing the reference domain number between the physical switches, the system can help ensure that a downstream device also using the learn and lock-on implementation cannot result in any physical member interface of the MLAG interface denying messages due to the downstream device locking onto the wrong peer's domain number.

Turning to FIG. 3, FIG. 3 is a simplified block diagram of a network element (e.g., the boundary clock nodes 108a, the boundary clock node 108b, or the network element 110) that includes the PTP engine 118. The PTP engine 118 can be provisioned in any suitable network element 110 or provided externally as a standalone element where appropriate. As is illustrated, this specific implementation includes suitable network interfaces, a message receiver, a message sender, an instance of a PTP protocol engine, a domain database manager, a logical interface resolution, a user configuration, and a PTP protocol state provisioned in an appropriate PTP protocol instance. It is imperative to note that this is just one possible implementation of the architecture, as countless others are well within the broad scope of the present disclosure.

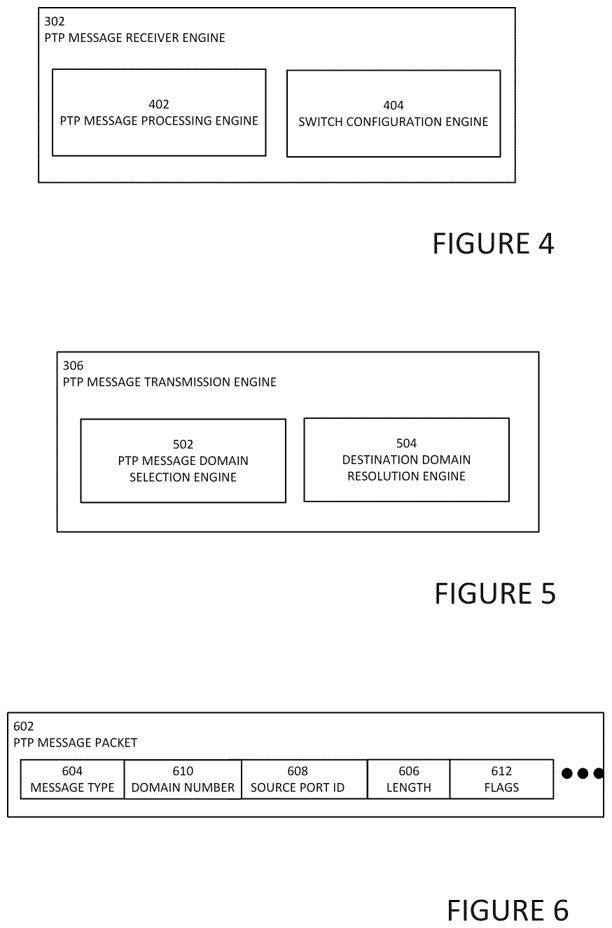

Referring back to FIG. 3, the PTP engine 118 can include a PTP message receiver engine 302, a PTP message parser engine 304, a PTP message transmission engine 306, an update domain engine 308, a domain database set 310, and a port 312. The PTP message receiver engine 302 is explained in more detail in FIG. 4. The PTP message parser engine 304 can be configured to parse the PTP message and check against the domain database set 310 to determine the correct processing, transmitting, and/or receiving of PTP messages. The PTP message transmission engine 306 is explained in more detail in FIG. 5. The update domain engine 308 can be configured to update the domain database set 310 based on received PTP messages. For example, if a new domain number is received in a PTP message and the domain number is an allowed domain number (e.g., in the allowed list of domain numbers), then the domain number can be added as an active domain number to the domain database set 310. Specifically, a domain number can become an active domain number, provided it is an allowed domain number, as provisioned by an operator or the corresponding architecture automatically. Allowed domain numbers represent a constraint that can be configured to limit which domain numbers would be considered active. In another example, if a PTP message is sent, a counter associated with the specific domain number in the PTP message can be updated to reflect that a PTP message with the specific domain number was sent. The domain database set 310 is a database of acceptable domain numbers, the state of PTP domains in the logical time domain, and other data and information related to specific domain numbers. The port 312 can be configured to send and receive PTP messages.

Turning to FIG. 4, FIG. 4 is a simplified block diagram of the PTP message receiver engine 302. Referring to FIG. 4, the PTP message receiver engine 302 can include a PTP message processing engine 402 and a switch configuration engine 404. The PTP message processing engine 402 can help process received and transmitted PTP messages. The switch configuration engine 404 can be configured to help determine the routing of both the incoming and the outgoing PTP messages.

Turning to FIG. 5, FIG. 5 is a simplified block diagram of the PTP message transmission engine 306. Referring to FIG. 5, the PTP message transmission engine 306 can include a PTP message domain selection engine 502 and a destination domain resolution engine 504. The PTP message domain selection engine 502 can select the domain for a PTP message. In an example, the domain for a PTP message is determined using the domain database set 310 and can be based on the port that will be receiving the PTP message. The destination domain resolution engine 504 can change the domain in the PTP message to match the domain for the PTP message that was determined by the PTP message domain selection engine 502.

Turning to FIG. 6, FIG. 6 is a simplified block diagram illustrating example details of a particular non-limiting implementation of a PTP message packet 602 to help coalesce multiple PTP domains. The PTP message packet 602 can include a message type portion 604, a source port ID 608, a length portion 606, a domain number portion 610, one or more flags portion 612, and other portions (not shown). The PTP message packet 602 can be in compliance with IEEE 1588-section 13.

Turning to FIGS. 7A-7F, FIGS. 7A-7F are simplified block diagrams illustrating example details of specific use case implementations of a system (e.g., system 100, 100a, 100b) for merging and/or intelligently grouping PTP domains. More specifically, FIG. 7A is an example Use Case #1, which includes a plurality of ordinary clock devices labeled generally 702 that are in communication with a plurality of outside broadcasting (OB) elements 704, 706, 708. In this simplified scenario, the clock devices would only support/have a single PTP domain. In this case, the OB elements are provided as trucks, which are equipped to run a respective boundary clock (B.C.) with each having their own respective global PTP domain, as is indicated. Each of the cameras attached to OB 1, for example, would be provisioned to global PTP domain 110, cameras attached to OB 2 would be provisioned to global PTP domain 120, and so forth.

Following along in this example scenario, each of the trucks are parked for a studio event to be broadcasted, and an operator associated with the studio event has made an election to have content (i.e., PTP messages) flowing on PTP domain 100, which is not compatible with any of the OB's domains at the outset. A global PTP domain can be established for each of the OBs to accommodate this event, where a particular port for this allocation is illustrated at 714, 716, 718. More specifically, an operator for each of the trucks can make a designation for a particular port to run PTP for translation purposes. The messages being communicated upstream to the facility would have a domain ID of 100, allowing for compatibility with a facility border router (FBR) 710. A border router is simply an IP router that is tasked with forwarding packets between autonomous systems. In the case of PTP message propagation, a facility border router can be connected to several domains. Messages from a facility's border router are effectively translated (akin to a network address translation (NAT) operation) to achieve a logical PTP translation between domain 110 and domain 100. Hence, incoming messages that have a domain ID of 110 would leave OB1 as translated messages having a domain ID 100. Similarly, messages coming back from the direction of the FBR 710 would incur the reverse translation from domain ID 100 to domain ID 110 for compatibility in the downstream direction. The facility's equipment associated with the studio event would not have to be involved in the translation happening for any of the OBs. Moreover, the facility border router may not even have the capacity to understand any messages not associated with domain 100. For all intents and purposes, FBR 710 believes that all communications happening across the plurality of OBs are aligned with domain 100.

FIG. 7B is an example Use Case #2 and, in this scenario, it is the FBR 710 that would perform the translation activities described above. The same consistency issue would be pervasive, as each of the OBs would have to ensure compatibility with their downstream devices. In this scenario, the OBs may have no enhanced intelligence for mapping domain IDs for this particular event. This logic would be provisioned in FBR 710. The OBs would believe they are exchanging messages with devices native to their respective domains. Conversely, FBR 710 would understand the specific domain ID to be used in sending messages to each of the OBs, and effectively translate in both downstream and upstream directions, as the OBs did in Use Case #1. An operator of FBR 710 can provision particular ports for this domain translation to occur for each of the OBs and this is generally illustrated at 720, 724, 728.

FIG. 7C is an example Use Case #3 that is a slight modification to Use Case #1 in which time sharing and/or resource allocation is provided as an option. This configuration could be relevant, for example, in situations where one or more OBs are seeking to combine media resources. Additionally, this configuration could be applicable in situations where one or more of the OBs have the intelligence to perform the translation activities, whilst the others would not have such capabilities. This configuration also illustrates the ability of each of the OBs to perform several different translations across multiple PTP domains.

Similar to Use Case #1, an operator of OB 704 has provisioned a port 734 for the translating activities in the upstream and downstream activities for a different OB (i.e., OB2), which is associated with global PTP domain 120. This same arrangement is provided across the other OBs. Specifically, an operator of OB2 has provisioned port 732 to assist/support in translating activities for a different OB (i.e., OB3), which is associated with global PTP domain 130. In this example configuration of FIG. 7C, the FBR is absent, while the OBs would continue to perform the translating activities for the ordinary clock devices 702 to ensure message compatibility. In a broad sense, a single clock device understands one domain, while an OB in this use case has the requisite intelligence to understand multiple domains and translate upstream/downstream accordingly.

FIG. 7D is an example Use Case #4 in which several clock devices 746, 748, 750 that have different associated domains are connected to a single port over a generic device 752 (e.g., a PTP unaware switch or a domain agnostic transparent clock (TC)) coupled to a switch 754, which includes a boundary clock having a global PTP domain. This coupling could be, for example, a hardware link. In contrast to the previous scenarios described above in which a single port services a single domain, this configuration allows for multiple domains to be serviced by a single port. An appropriate table having a translation entry can have multiple incoming domain IDs being mapped to multiple outgoing domain IDs. Hence, incoming messages having domains 110, 120, 130 can be mapped to domain 4 to be compatible with a grand master 756 that understands those messages. Such a table can be provided in any suitable storage element to be provided in switch 754.

This Use Case #4 could be relevant to many scenarios in which learning occurs. For example, this configuration could be used in learning the domain number translation based on a port identity of a connected ordinary clock device. A learning use case includes a scenario in which an operator does not wish to reconfigure a device for any change in downstream devices/change in configuration of connected devices. In learning scenarios, a device can learn domain numbers based on the source port identity, and the domain number header fields of messages from each downstream device. This allows it to understand which domain number to use when sending messages back to those devices. This happens as opposed to having a statically configured domain number/set of domain numbers for a port to translate and, further, it can be viewed as analogous to static versus dynamic network address translations (NATs). Separately, switch 754 can understand which translations it should be performing based on incoming messages. This could be particularly useful in VLAN scenarios in which each clock device is linked to a single VLAN, sending PTP messages over the VLAN and to switch 754. Based on the incoming port and the VLAN identified, switch 754 understands which translation to perform based on the respective domain ID identified in the incoming messages. While it appears that there are three connected ports at switch 754, it is actually a single port 758 with multiple VLANs being multiplexed on that port. In addition, port 758 can be used for learning by switch 754 through monitoring clock devices that are downstream (regardless of their associated VLAN) to identify which devices are communicating using a particular domain. Switch 754 has logic to identify incoming messages from both directions in order to perform the translation functions and, thereby, avoids the scenario in which the VLANs would have to be configured to execute this mapping and/or translation.

In a general sense, VLAN scenarios relate to virtualizing the handling of domain numbers beyond just being per physical port. An operator can configure a domain number statically, or use learning-based translations on a per-VLAN basis. Hence, rather than just have the configured port have a single configuration for everything connected physically to that port, it can have different behaviors based on the VLAN. In this way, the VLAN configuration allows one physical port to behave like multiple independent ports in terms of a single translation.

FIG. 7E is an example Use Case #5 in which port 758 is learning multiple downstream domain IDs from clock devices 762, 764, 766, 768. In addition, a simple static translation occurs between switch 754 and grand master 756. FIG. 7E is also illustrative of two different implementations for handling downstream devices. In this scenario, there are three separate VLANs provided for clock devices 762, 764, 766, 768, along with a switch 772 connected to a separate VLAN. A slight difference to that detailed above is that, while switch 754 has logic to use its port 758 to identify a VLAN and a domain from incoming/downstream messages from any device, in this instance, the VLAN configuration is static. This is illustrated by the switchport mode trunk, as this translation is being statically described by the VLAN. This eliminates the need to learn all of the downstream devices and their associated VLANs, as switch 754 would only need to know the VLAN to perform its translations. This VLAN information can be used to translate multiple domains to a single domain for messages that would ultimately be compatible with grand master 756, which has its own different domain.

FIG. 7F is an example Use Case #6 that is a slight modification to Use Case #5. In this configuration, there are two switches 786, 788 provided in an MLAG 784, which allows them to form (appear as) a single PTP device in the network. In this case, two ports 792 and 794 are provisioned for a static translation for internal MLAG messages exchanged between switches 786, 788. This configuration also has the capability of exchanging state information between switches 786, 788 so that when either of the switches learns about a downstream device, that information can be exchanged with its peer. Specifically, MLAG member switches learn the mapping of an MLAG interface 790 to the domain number from messages forwarded over the peer link. This learning could be shared automatically or provided in messaging in any other appropriate manner. In addition, one of these peers may be designated as an active switch (i.e., the switch performing the majority of the workload, learning information to be shared to its peer, etc.). MLAG peers may operate PTP on a “private domain” number or the global domain. Both switches are capable of performing the translation activities described above with reference to Use Case #5 and, as such, the physical interface members of each MLAG interface share domain translation rules. It is imperative to note that any of the aforementioned use cases can include a multi-chassis arrangement in which several switches are provisioned in a similar fashion to provide, for example, link redundancy, resource sharing, and intelligence and logic for each other.

To summarize, the simplest set of implementations are those that translate statically per logical PTP interface. The PTP interface can replace the incoming PTP message's domain number based on the active domain numbers database, which includes a single entry and is the one configured statically. This implementation would cover the requirements of Use Cases #1, #2, #3, and #6, but does not support handling multiple locally connected domain number regions for a single logical interface, does not support automatically managing region-merging (manual configuration required), and strictly prevents accidental rogue domain numbers from merging.

When multiple domain numbers are supported statically on the interface, the PTP interface no longer has a notion of what domain number to use by default. To support handling and generating PTP messages for multiple domain numbers on a single interface, a database of the active domains is maintained per interface. Received messages are accepted if they are a member of the active domains. Transmitted messages may be replicated per connected region's domain number (from the active domains) if required. The multiple static domain number translation implementation covers the requirements of Use Cases #1-#6, supports handling multiple domain number regions connected to the logical interface, and requires some manual configuration to statically configure the expected/allowable domain numbers (no automatic learning).

Similar to the static translation implementation, the domain number learn and lock-on implementation results in an active domain numbers database with a single entry per logical PTP interface. The difference being that the entry is not statically configured, rather it is determined based on the domain number seen in incoming messages received on the interface. Once the interface receives a PTP message, it can learn that domain number and then translate to and from that domain number only. The domain number learn and lock-on implementation can be used to overwrite the domain number field for outgoing PTP messages.

In some examples, for the duration of being in the locked-on state, no other PTP domain numbers are active on the interface unless the interface is configured by an overriding policy, for example, to include the reference domain number as well. For the duration of not being in the locked-on state, the domain number handling is the default for the reference clock configuration. The domain number learn and lock-on implementation includes the parameters of Use Cases #1, #2, #3 and #6 and does not support multiple domain number regions connected to the logical interface at once. As discussed herein, the learning implementation of the translation activities does not lock on and, instead, learns domain numbers associated with a particular port identity of the other devices, subsequently using that to communicate with one, or with many downstream devices using the correct domain number.

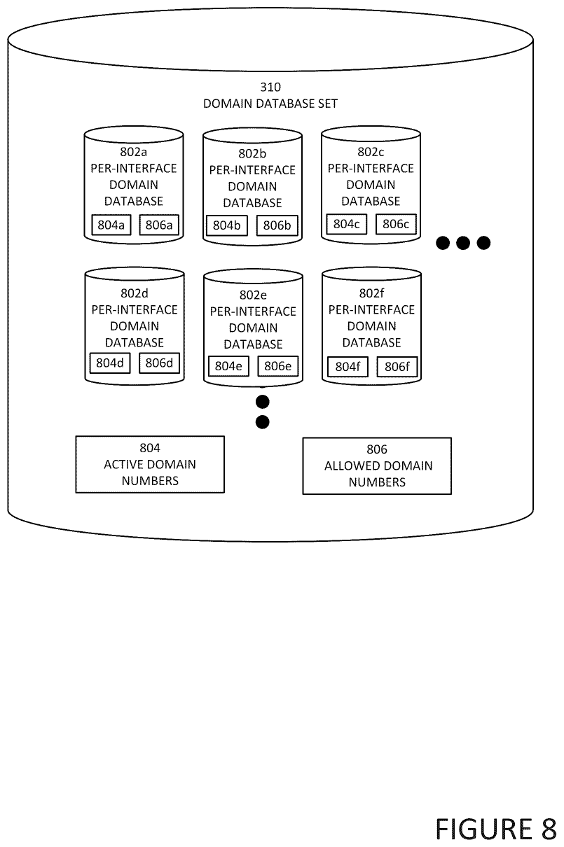

Turning to FIG. 8, FIG. 8 is a simple block diagram of the domain database set 310, in accordance with an embodiment of the present disclosure. As illustrated in FIG. 8, the domain database set 310 can include one or more per-interface domain databases 802a-802f. The domain database set 310 can also include active domain numbers 804 and allowed domain numbers 806. In some examples, each per-interface domain database 802a-802f includes active domain numbers 804 and allowed domain numbers 806. For example, as illustrated in FIG. 8, per-interface domain database 802a would include active domain numbers 804a and allowed domain numbers 806a, per-interface domain database 802b would include active domain numbers 804b and allowed domain numbers 806b, per-interface domain database 802c would include active domain numbers 804c and allowed domain numbers 806c, per-interface domain database 802d would include active domain numbers 804d and allowed domain numbers 806d, per-interface domain database 802e would include active domain numbers 804e and allowed domain numbers 806e, and per-interface domain database 802f would include active domain numbers 804f and allowed domain numbers 806f. Each per-interface domain database 802a-802f includes information about the translations the interface needs to perform. For example, the per-interface domain database 802a can be associated with a specific network element (e.g., boundary clock node 108a) and the per-interface domain database 802a can include information about the translations the specific network element needs to perform.

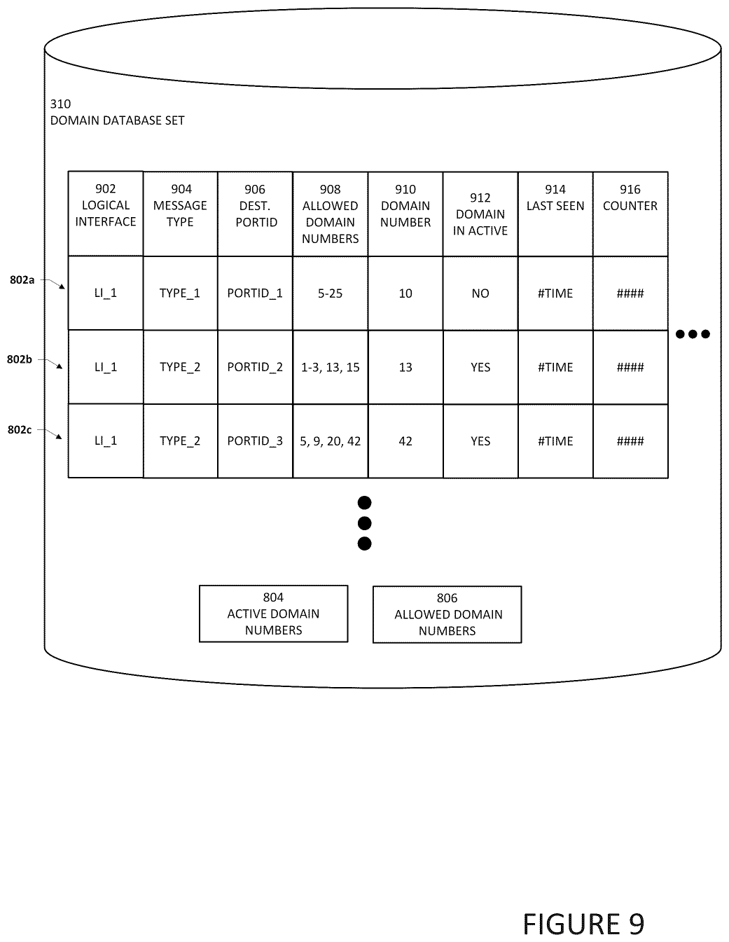

Turning to FIG. 9, FIG. 9 illustrates example details of the domain database set 310, in accordance with an embodiment of the present disclosure. As illustrated in FIG. 9, the domain database set 310 can include the per-interface domain databases 802 as shown in FIG. 8. Each per-interface domain database 802a-802f can include state information and/or data related to a specific logical interface and/or domain. More specifically, each per-interface domain database 802a-802f can include a logical interface field 902, a message type field 904, a destination portID field 906, an allowed domain number field 908, a domain number field 910, a domain in active field 912, a last seen field 914, a counter field 916, and other fields related to state information and/or data related to a specific logical interface and/or domain. The logical interface field 902 includes the ID of the logical interface for the PTP message. The message type field 904 includes the message type of the PTP message. The destination portID field 906 includes the portID of the destination of the PTP message.

Together, data in the logical interface field 902, the message type field 904, and the destination portID field 906 are used to create a lookup table to determine the domain number that should be included in the PTP message and allows each per-interface domain database 802a-802f to serve as a lookup table. For example, each per-interface domain database 802a-802f is associated with a logical interface (e.g., per-interface domain database 802a is associated with logical interface LI_1). When the logical interface is determined, then the message type is determined, after the message type is determined, then the destination PTP portID is determined, from there, the domain number for the PTP message can be determined. For example, if the logical interface is LI_1, then per-interface domain databases 802a-802c, illustrated in FIG. 9 are referenced. If the message type is TYPE_1 (in the message type field 904) and the destination portID is PORTID_1 (destination portID field 906), then the domain is ten, as evidenced by the domain number field 910 associated with the per-interface domain databases 802a. If the message type is TYPE_2 (in the message type field 904) and the destination portID is PORTID_2 (destination portID field 906), then the domain is thirteen, as evidenced by the domain number field 910 associated with the per-interface domain databases 802b. If the message type is TYPE_2 (in the message type field 904) and the destination portID is PORTID_3 (destination portID field 906), then the domain is forty-two, as evidenced by the domain number field 910 associated with the per-interface domain databases 802c. The domain in use/active field 912 includes data about whether or not the domain is currently in use. The last seen field 914 includes data about the last time a PTP message from a specific domain was received. In some examples, the counter field 916 includes a counter that represents the PTP message count from the specific domain. In other examples, the counter field 916 includes a counter that is representative of a port count associated with the logical interface, a port state related count, a domain number related count, or some other count depending on the operator's choice and system/design constraints.

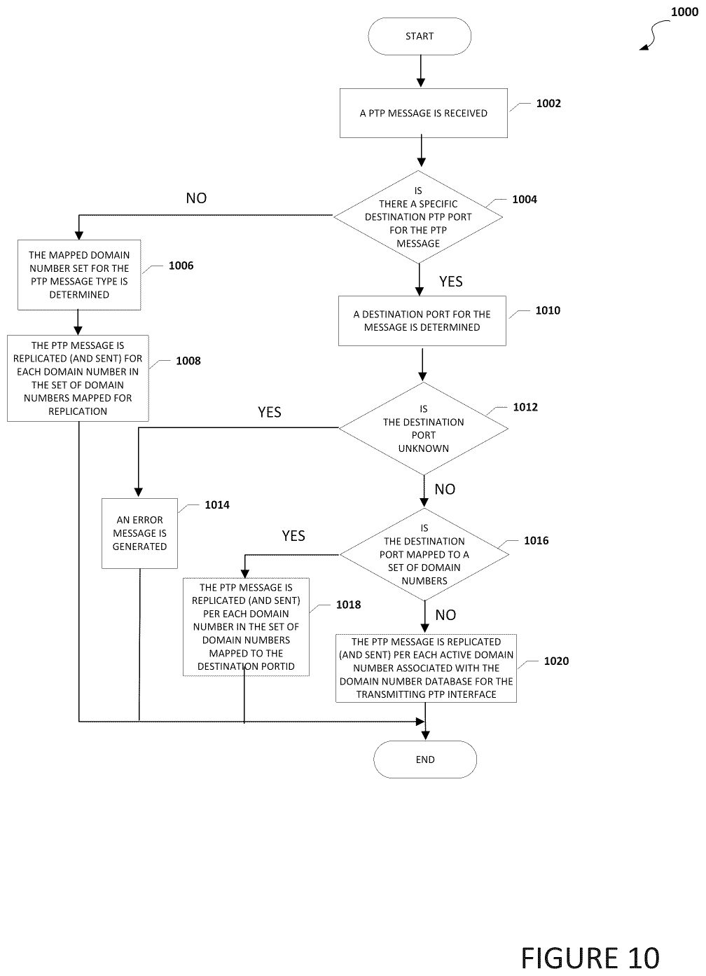

Turning to FIG. 10, FIG. 10 is an example flowchart illustrating possible operations of a flow 1000 that may be associated with a system, an apparatus, and a method to enable sending a PTP message to multiple PTP domains. In some examples, one or more operations of flow 1000 may be performed by the PTP engine 118, the PTP message receiver engine 302, the PTP message parser engine 304 and/or the PTP message transmission engine 306. At 1002, a PTP message is received. That PTP message could be an internally created message, or created externally based on particular network configurations and/or based on specific communication protocols. For example, the PTP message may be received from a network element (e.g., the boundary clock nodes 108a, the boundary clock node 108b, or the network element 110) that is physically separate from the network element that received the PTP message.

In another example, the PTP message is a new PTP message and it is internally generated and received. At 1004, the system determines if there is a specific destination PTP port for the PTP message. If there is not a specific destination PTP port for the PTP message, the mapped domain number set for the PTP message type is determined, as in 1006. At 1008, the PTP message is replicated for each domain number in the set of domain numbers mapped for replication. If there is a specific destination PTP port for the PTP message, a destination port for the message is determined, as in 1010. At 1012, the system determines if the destination port is unknown. If the destination port is unknown, an error message is generated, as in 1014. If the destination port is known, the system determines if the destination port is mapped to a set of domain numbers, as in 1016. If the destination port is mapped to a set of domain numbers, PTP message is replicated per each domain number in the set of domain numbers mapped to the destination portID, as in 1018. If the destination port is not mapped to a set of domain numbers, the message can be replicated per each active domain number associated with the domain number database for the transmitting PTP interface, as in 1020. In a general sense, a plurality of PTP messages are being replicated for multiple active domain numbers.

In various modes, the architecture can elect to create copies of PTP messages to be sent out, giving each copy a different domain number when it does not already have a confirmed domain number to use for a given endpoint to which it is sending. There are many possible configurations for message creation using the 0-255 domain numbers. These can include: 1) a naive/broadcast in which the architecture creates a copy for all domain numbers and ensures that the receiver receives at least one copy; 2) active domain numbers in which the architecture can create copies for domain numbers previously seen/considered active (this approach may miss newly added domain number regions); and 3) sending messages to a range/set of domain numbers as configured by an operator, which allows for configuration from an operator to broadcast on specific domain numbers.

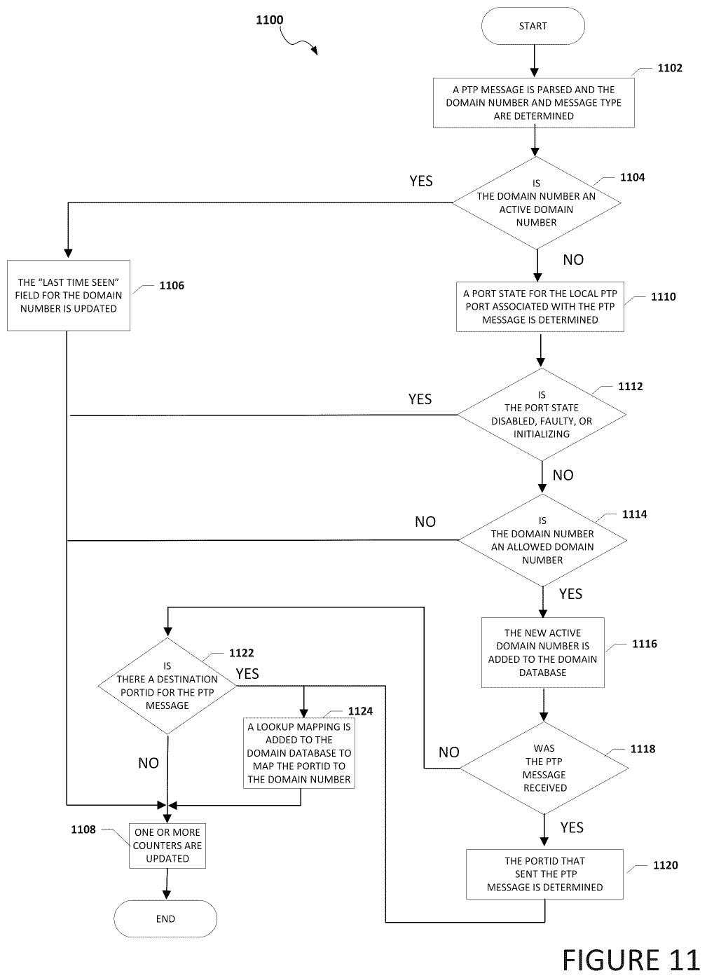

Turning to FIG. 11, FIG. 11 is an example flowchart illustrating possible operations of a flow 1100 that may be associated with a system, an apparatus, and a method to enable adding a lookup mapping to a domain database. In some examples, one or more operations of flow 1100 may be performed by the PTP engine 118, the PTP message receiver engine 302, the PTP message parser engine 304, the PTP transmission engine 306, and/or the update domain engine 308. At 1102, a PTP message is parsed, and the domain number and message type are determined. At 1104, the system determines if the domain number is an active domain number. If the domain number is an active domain number, the “last time seen” filed for the domain number is updated, as in 1106. At 1108, one or more counters are updated. For example, a counter representing the number of times the domain number is used can be updated.

If the domain number is not an active domain number, a port state for the local PTP port associated with the PTP message is determined, as in 1110. At 1112, the system determines if the port state is disabled, faulty, or initializing. If the port state is disabled, faulty, or initializing, one or more counters are updated, as in 1108. For example, a counter representing the number of times a domain number for the message type and the port was ignored due to the port state being disabled, faulty, or initializing can be updated. If the port state is not disabled, faulty, or initializing, the system determines if the domain number is an allowed domain number, as in 1114. If the domain number is not an allowed domain number, one or more counters are updated, as in 1108. For example, a counter representing the number of times it has been determined that the domain number is not an allowed domain number can be updated. If the domain number is an allowed domain number, the new active domain number is added to the domain database, as in 1116.

Note that aforementioned counters can be different from each other and other counters can readily be used without departing from the scope of the present disclosure. For example, in the scenario above, one counter could count packets for a message-type “announce” on domain number “10” for port “ethernet10” when the port was in a non-receiving state. The second counter can count packets for a message-type “sync” received on “ethernet10” that had a domain number “11” which is a disallowed domain number. Hence, in one generic sense these example counters are being used to track different statistics, and each of them would have varying degrees of usefulness and possibilities that would be of interest to network operators having specific networking needs.

At 1118, the system determines if the PTP message was received. The system determines if the PTP message was received from the network (e.g., from a PTP peer clock connected to the port) or if the PTP message was a generated PTP message that is being communicated to a new port. If the PTP message was received, the portID that sent the PTP message is determined, as in 1120. At 1124, a lookup mapping is added to the domain database to map the portID to the domain number.

At 1108, one or more counters are updated. For example, a counter representing the number of times the portID is mapped to the domain number can be updated. If the PTP message was not received, for example, the PTP message was generated and is being sent to a new port, the system determines if there is a destination portID for the PTP message, as in 1122. If there is not a destination portID for the PTP message, one or more counters are updated, as in 1108. For example, a counter representing the number of times a PTP message does not have a destination portID can be updated. If there is a destination portID for the PTP message, a lookup mapping is added to the domain database to map the portID to the domain number, as in 1124 and one or more counters are updated, as in 1108. For example, a counter representing the number of times the portID is mapped to the domain number can be updated.

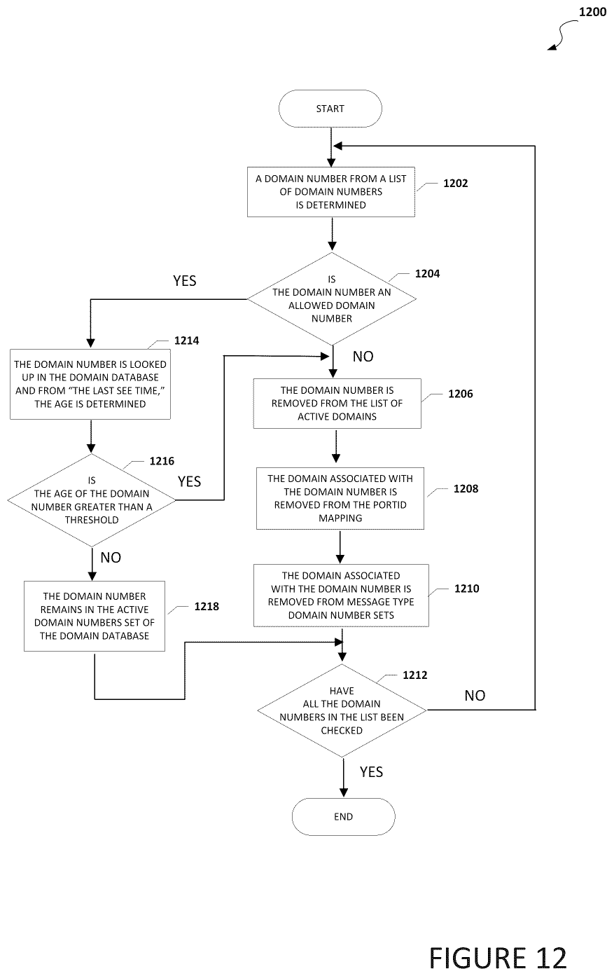

Turning to FIG. 12, FIG. 12 is an example flowchart illustrating possible operations of a flow 1200 that may be associated with a system, an apparatus, and a method to help enable removing a domain number from a list of active domain numbers. In some examples, one or more operations of flow 1200 may be performed by the PTP engine 118, the PTP message receiver engine 302, the PTP message parser engine 304, the PTP transmission engine 306, and/or the update domain engine 308. At 1202, a domain number from a list of domain numbers is determined. The list of domain numbers may be a list of the active domain numbers, a single domain number, a range of domain numbers, specific domain numbers, the domain numbers allowed by the PTP protocol, or some other list of one or more domain numbers.

At 1204, the system determines if the domain number is an allowed domain number. If the domain number is not an allowed domain number, the domain number is removed from the list of active domain numbers, as in 1206. At 1208, the domain associated with the domain number is removed from the portID mapping. At 1210, the domain associated with the domain number is removed from domain number sets (e.g., message type, portID, active domain number sets, etc.). At 1212, the system determines if the domain numbers in the list of domain numbers have been checked. If the domain numbers in the list have not been checked, the system returns to 1202, a domain number from a list of domain numbers is determined, and the process starts again.

Referring back to 1204, if the domain number is an allowed domain number, the domain number is looked up in the domain database and from the “last seen time” the age of the domain number is determined, as in 1214. At 1216, the system determines if the age of the domain number is greater than a predetermined threshold. For example, the predetermined threshold may be minutes, hours, days, weeks, or some other time threshold. If the age of the domain number is greater than the predetermined threshold, the domain number is removed from the list of active domains, as in 1206. If the age of the domain number is not greater than the predetermined threshold, the domain number remains in the active domain number set of the domain database, as in 1218. At 1212, the system determines if the domain numbers in the list have been checked.

If the domain numbers in the list of domain numbers have not been checked, the system returns to 1202, a domain number from a list of domain numbers is determined, and the process starts again. If the domain numbers in the list of domain numbers have been checked, the process ends. Substantial flexibility is provided by the architecture discussed herein for coalescing multiple precision time protocol domains in that any suitable arrangements, chronologies, configurations, and timing mechanisms may be provided without departing from the teachings of the present disclosure.

Note that embodiments of the ordinary clock nodes 106, boundary clock nodes 108, and the network element 110 may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces represented by network interfaces 26, may include physical ports (e.g., Ethernet, USB, HDMI, etc.), interfaces for wired and wireless internal subsystems, and the like. Similarly, each of the nodes and user equipment (e.g., mobile devices) of systems 100, 100a, and 100b can also include suitable interfaces for receiving, transmitting, and/or otherwise communicating data or information in a network environment.

The ordinary clock nodes 106, boundary clock nodes 108, the network element 110, and other associated or integrated components can include one or more memory elements having software and/or hardware for storing information to be used in achieving operations associated with enabling the management of multiple PTP domains, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in system 100 could be provided in any database, register, table, cache, queue, control list, or storage structure, based on particular needs and implementations, all of which could be referenced in any suitable time frame. Any of the memory or storage options discussed herein should be construed as being encompassed within the broad term ‘memory element’ as used herein in this Specification.

In example embodiments, the operations for enabling the management of multiple PTP domains, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements (e.g., memory) can store data used for the operations described herein. This includes the memory elements being able to store software, logic, code, or processor instructions that are executed to carry out the PTP domain management activities described in this Specification.

Regarding a physical implementation of the ordinary clock nodes 106, boundary clock nodes 108, the network element 110, and associated components such as the PTP engine 118, the PTP message receiver engine 302, the PTP message parser engine 304, the PTP transmission engine 306, the update domain engine 308, etc., any suitable permutation may be assembled or otherwise provisioned based on particular needs and requirements, including the design of the particular network in which the ordinary clock nodes 106, boundary clock nodes 108, and the network element 110 are implemented. In one embodiment, the ordinary clock nodes 106, boundary clock nodes 108, and/or the network element 110 may be integrated with the PTP engine 118, the PTP message receiver engine 302, the PTP message parser engine 304, the PTP transmission engine 306, and the update domain engine 308, and therefore share hardware resources such as the processors and the memory. Alternatively, the ordinary clock nodes 106, boundary clock nodes 108, and/or the network element 110 may be implemented separately, including being provisioned as a stand-alone device. In this alternative implementation, the PTP engine 118, the PTP message receiver engine 302, the PTP message parser engine 304, the PTP transmission engine 306, and the update domain engine 308 may be provided with separate hardware resources including one or more processors and memory elements.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. Substantial flexibility is provided by the architecture to enable managing multiple precision time protocol domains in that any suitable arrangements, chronologies, configurations, and timing mechanisms may be provided without departing from the teachings of the present disclosure.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the architecture to enable managing multiple precision time protocol domains and its teachings are readily scalable and can accommodate a large number of components, as well as more complicated/sophisticated arrangements and configurations. Accordingly, the examples provided should not limit the scope or inhibit the broad teachings of the architecture to manage multiple precision time protocol domains and as potentially applied to a myriad of other architectures.

It is also important to note that the operations in the preceding flow diagrams (i.e., FIGS. 10-12) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method for processing precision time protocol (PTP) messages in a logical time domain at a network element, the method comprising:
receiving an incoming PTP message at a logical PTP interface, which corresponds to one or more PTP ports of the network element, wherein the incoming PTP message includes a first domain number; and
translating the first domain number of the incoming PTP message into a second domain number to be included in a field of an outgoing PTP message, wherein the translating includes identifying an active domain number entry in an active domain numbers database that includes the second domain number and that is part of a configuration, and wherein the configuration allows domain number translations for a PTP region, which is defined by its PTP domain and which corresponds to the logical PTP interface.

2. The method of claim 1, wherein a PTP instance translates one or more PTP messages between a plurality of PTP regions corresponding to a plurality of network elements.

3. The method of claim 1, wherein the configuration includes domain number translations for one or more logical PTP interfaces that are defined for a predetermined duration.

4. The method of claim 1, further comprising:
maintaining the active domain numbers database that includes a configured set of active domains; and
accepting a plurality of incoming PTP messages if they are members of at least one of the configured set of active domains as indicated by their respective domain number field.

5. The method of claim 1, further comprising:
automatically accepting a plurality of PTP messages based on a domain number field of the plurality of PTP messages being a member of the active domain numbers database, which includes a default domain of the network element.

6. The method of claim 5, wherein if a destination PTP port ID associated with the plurality of the PTP messages does not have a known domain number, the plurality of PTP messages are replicated for multiple active domain numbers.

7. The method of claim 1, wherein the logical PTP interface corresponds to one or more PTP ports, which are virtually grouped as a multi-chassis link aggregation (MLAG) interface representing physical ports on at least two separate physical switches.

8. The method of claim 1, wherein the logical PTP interface corresponds to one or more PTP ports, which are virtual local area network (VLAN) aware ports described by a physical port and a PTP VLAN on which particular PTP messages are received.

9. The method of claim 1, wherein each of a plurality of entries in the active domain numbers database correspond to a single logical PTP interface.

10. The method of claim 1, further comprising:
automatically dropping a plurality of PTP messages based on a domain number field of the plurality of the PTP messages not being a member of the active domain numbers database.

11. The method of claim 1, further comprising:
adding one or more translations to the active domain numbers database based, at least in part, on receiving a particular PTP message and associating a source port identity with a particular domain number from the particular PTP message such that outgoing PTP messages destined for the source port identity are automatically associated with the particular domain number.

12. A network element, comprising:
a logical precision time protocol (PTP) interface, which corresponds to one or more PTP ports of the network element; and
a PTP engine configured to:
translate a first domain number of an incoming PTP message into a second domain number to be included in a field of an outgoing PTP message, wherein the translating includes:
identifying an active domain number entry in an active domain numbers database that includes the second domain number and that is part of a configuration, and wherein the configuration allows domain number translations for a PTP region, which is defined by its PTP domain and which corresponds to the logical PTP interface.

13. The network element of claim 12, wherein the configuration includes domain number translations for one or more logical PTP interfaces that are defined for a predetermined duration.

14. The network element of claim 12, wherein the PTP engine is further configured to:
automatically accept a plurality of PTP messages based on the plurality of PTP messages being a member of the active domain numbers database, which includes a default domain of the network element.

15. The network element of claim 12, wherein the logical PTP interface corresponds to one or more PTP ports, which are virtually grouped as a multi-chassis link aggregation (MLAG) interface representing physical ports on at least two separate physical switches.

16. The network element of claim 12, wherein the logical PTP interface corresponds to one or more PTP ports, which are virtual local area network (VLAN) aware ports described by a physical port and a PTP VLAN on which particular PTP messages are received.

17. The network element of claim 12, wherein each of a plurality of entries in the active domain numbers database correspond to a single logical PTP interface.

18. The network element of claim 12, wherein the PTP engine is further configured to:
update a last seen field in the active domain numbers database for a specific domain number when a particular PTP message with a particular domain number is received.

19. Computer-readable medium for processing precision time protocol (PTP) messages in a logical time domain, the computer-readable medium containing instructions executable by a processor for:
receiving an incoming PTP message at a logical PTP interface, which corresponds to one or more PTP ports of a network element, wherein the incoming PTP message includes a first domain number; and
translating the first domain number of the incoming PTP message into a second domain number to be included in a field of an outgoing PTP message, wherein the translating includes identifying an active domain number entry in an active domain numbers database that includes the second domain number and that is part of a configuration, and wherein the configuration allows domain number translations for a PTP region, which is defined by its PTP domain and which corresponds to the logical PTP interface.

20. The computer-readable medium of claim 19, wherein the medium contains instructions executable by the processor for:
maintaining the active domain numbers database that includes a configured set of active domains; and
accepting a plurality of incoming PTP messages if they are members of at least one of the configured set of active domains as indicated by their respective domain number field.
